(19) United States
(12) Patent Application Publication
(10) Pub. No.: US 2020/0273125 A1
(43) Pub. Date: Aug. 27, 2020

(54) METHODS FOR NAVIGATING COLLEGE CURRICULUM PROGRAMS

(71) Applicant: Bakersfield College, Bakersfield, CA (US)

(72) Inventors: Sonya Christian, Bakersfield, CA (US); Craig Hayward, Bakersfield, CA (US); Howard Wayne Skipper, Eugene, OR (US); Van Ton-Quinlivan, Burlingame, CA (US); Jennifer Dawn Smith, Eugene, OR (US)

(21) Appl. No.: 16/709,115

(22) Filed: Dec. 10, 2019

Related U.S. Application Data
(60) Provisional application No. 62/811,359, filed on Feb. 27, 2019.

(51) Int. Cl. G06Q 50/20; G06Q 30/02; G06F 16/215

(52) U.S. Cl. CPC G06Q 50/205; G06F 16/215; G06Q 30/0201

(57) ABSTRACT

The present application discloses methods and systems configured to help students navigate and understand the requirements and options for courses selection, academic programs, and transferring credits to or from another college or university. Presented are several innovative graphical methods with an automated cleaning back-end method and device designed to present in intuitive ways the requirements of and paths toward degree completion. In some embodiments, a program mapper webtool takes static course information and transforms it into an interactive online tool. The program mapper uses data that has been verified or cleaned by a data cleanup tool. The program mapper presents the verified data as pathways to guide students through a selected educational path. The program mapper may further include an authoring tool that allows authorized users to build school-specific program maps based on its own academic programs and requirements.

### CROSS-REFERENCE TO RELATED APPLICATIONS

This application claims the benefit of U.S. Provisional Application No. 62/811,359 filed on Feb. 27, 2019, the contents of which are hereby incorporated by reference.

### FIELD OF THE INVENTION

The present disclosure relates generally to computer programs for organizing school curriculum programs, and more specifically to a web tool that allows schools and students to navigate academic programs and courses and create a personalized curriculum program map.

### BACKGROUND OF THE INVENTION

Many colleges publish their courses in a course catalog. Students progressing through an academic program have to sift through printed course catalogs or online listings of course offerings. With no visual representation of the course sequence or course progression, students tend to get off track, and find themselves in unnecessary classes that create delays in their graduation. They also need to cross-reference the college's graduation requirements on the academic programs they choose, to make sure they are on track. Navigating through college curriculum programs requires specialized knowledge of the courses offered by the school and accurate understanding of the academic programs designed by the school. It is often necessary for colleges to assign a counselor to each student to guide them through their course selection.

When a student switches from one academic program to another or transfers from one college to another, it is often difficult to align the student's past academic records with the requirements of the new program or the new school. With increasing demands from the current job market, students need a path that helps them enter the workforce more speedily. There is a need, therefore, of a tool that can present course requirements, course sequences and graduation timelines in a clean, organized, efficient, and intuitive manner.

### SUMMARY OF THE INVENTION

Accordingly, it is an objective of the present application to teach methods and systems for organizing academic program information, integrating college curriculum programs with students' career selections, and presenting a program mapper for use by students to select classes based on academic requirements and/or post-graduation economic data.

Various embodiments described herein relate to a method of processing curriculum data for helping a student navigate curriculum programs. The method may include collecting academic program data of a first institution, cleaning the collected academic program data, and publishing the cleaned academic program data, including in a program mapper, wherein the program mapper is an online tool configured to present a program pathway based on objectives specified by the student.

In some embodiments, the method may include collecting occupational and labor market data, wherein the program mapper is configured to integrate and display the collected academic program data and the collected occupational and labor market data.

In some embodiments, the method may include removing conflicting data collected from different sources. Additionally, in some embodiments, the method may include correcting inaccurate data by determining which source is accurate. The method may also include time information related to the course requirement for achieving the objective specified by the student.

In some embodiments, the method may have one or more program maps, with each program map showing one or more possible course sequences for earning a program's award. Additionally, in some embodiments, the method may include one or more curriculum areas, wherein each curriculum area includes two or more classes that meet a same requirement.

In some embodiments, the method may include collecting academic program data of a second institution, integrating the academic program data of the first institution with the academic program of the second institution, and publishing the integrated program data in the program mapper, where the integrated program data allows a student to matriculate in both institutions to achieve one of the objectives of the student.

Various embodiments described herein may also relate to a course management system including an input/output device for receiving academic program data. The course management system may include one or more processors configured to clean the academic program data, and publish the academic program data, for example, in a program mapper, where the program mapper is an online tool configured to present, on the I/O device, a program pathway based on objectives specified by the student.

In some embodiments, the course management system may maintain records of updates to academic program data made during the cleaning of the data, such that the same updates can be made to new data at a later point in time. In some embodiments, the course management system may collect occupational and labor market data, and the program mapper is configured to integrate the collected academic program data and the collected occupational and labor market data, and publish the integrated data.

In some embodiments, the course management system may include removing conflicting data collected from different sources. Additionally, in some embodiments, in the course management system the program pathway may include a course requirement for achieving the objective specified by the student. In some embodiments, in the course management system the program pathway may include time information related to the course requirement for achieving the objective specified by the student.

In some embodiments, the course management system may further include generating, in response to a school administrator's specification, program maps based on the cleaned academic data, with each program map showing one or more possible course sequences for earning a program award. In some embodiments, the course management system may be configured to keep track of the student's progression along the program pathway towards the objective.

Various embodiments described herein relate to a curriculum program mapping system that is configured to help students navigate curriculum programs. The system includes a data cleanup tool for cleaning academic program data collected from different sources, an authoring tool for academic stakeholders to create program maps out of the cleaned data, and a program mapper for presenting the cleaned program data as program pathways for students to navigate curriculum programs.

In some embodiments, a program map shows a possible course sequence for earning a program award. A program pathway comprises one or more program maps and can be presented in a program mapper. In some embodiments, a program mapper may include one or more program groups. Each program group may be viewed as a career pathway and includes a group of careers that share common themes or require similar skills. In some embodiments, each program group comprises one or more programs.

Each program may be viewed as a specific academic program offered by a college, for example, Biology. For each program, the program mapper may present data such as program type, award type, TOPE code (career mapping code), and a program description. Links to program videos may also be included in the program mapper. In one embodiment, data on salary, industrial growth, and careers related to each program are also stored and displayed in the program mapper.

In some embodiments, the program mapper comprises one or more program maps. Each program map shows one possible course sequence students can take to earn the program's award. There may be more than one pathway per program. Pathways may have a destination, such as ‘Pathway To: CSU’ or ‘Pathway to UC’ or ‘Pathway To Career’. In some embodiments, a program mapper further comprises one or more curriculum areas. Each curriculum area contains several courses that are grouped together so that students are able to choose one class among several listed in the curriculum area to meet the same requirement.

In some embodiments, a data cleanup method or tool is disclosed to prepare data for being imported into the program mapper. The data cleanup tool ensures that all of the data from the various import locations is consolidated into a clean curriculum, that required fields are filled in, and that there are no duplicate entries or junk characters. In some embodiments, an authoring tool is provided for school administrators to create program maps based on the data that has been imported and cleared.

### BRIEF DESCRIPTION OF THE DRAWINGS

These and other features of the present disclosure will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIG. 1 is an exemplary user interface illustrating various different programs according to some embodiments.

FIG. 2 illustrates an exemplary degree map in a program group according to some embodiments.

FIG. 3a illustrates an exemplary program map according to some embodiments.

FIG. 3b illustrates an exemplary program map with curriculum area according to some embodiments.

FIG. 4 illustrates exemplary economic data for a pathway according to some embodiments.

FIG. 5 illustrates an exemplary workflow for the data cleanup tool according to some embodiments.

FIG. 6 is a flowchart representation of a method of cleaning and publishing academic program data according to some embodiments.

FIG. 7 is a block diagram of a course management system according to some embodiments.

FIG. 8 illustrates an exemplary curriculum mapping system including a program mapper workflow according to some embodiments.

### DETAILED DESCRIPTION

Embodiments of the disclosure are described more fully hereinafter with reference to the accompanying drawings, in which preferred embodiments of the disclosure are shown. The various embodiments of the disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

University students often have a difficult time finding the exact course requirements and detailed programs for their academic goals. An automated and efficient tool that provides educational planning for students, parents, and school counselors is needed in the art. The novel system described herein solves these problems, making educational planning faster and more accurate. Embodiments include advanced tools that provide information on academic programs as well as resources on post-graduation economic data such as job prospects and salaries. The present application discloses methods and systems designed to help students understand college catalogs so that they can more efficiently visualize and navigate the program curriculum. Some embodiments help students visualize their programs in the context of expected employment outcomes. With the methods and systems disclosed herein, students are further able to rely on the course sequencing work the school faculty undertook, more accurately, clearly, and efficiently.

Embodiments enable students to find programs and classes that help them achieve their own career goals. Many students may be attending school part-time and need to understand how to complete their classes and degrees in their time available. Similarly, some students plan to transfer, or use their credits at other schools. Embodiments disclosed herein enable students to more accurately and efficiently visualize and validate their plans. Novel features of the embodiments include visual representations of how classes fit together, options to view course completion paths as part-time students, options to view classes that are applicable for transfer, and options to view developmental classes. Additionally, the embodiments provide capabilities such as viewing additional certificates or licenses available within pathways, key program and course information with detailed explanations, relevant opportunities outside coursework such as workshops and events, clear progress milestones as well as up-to-date information.

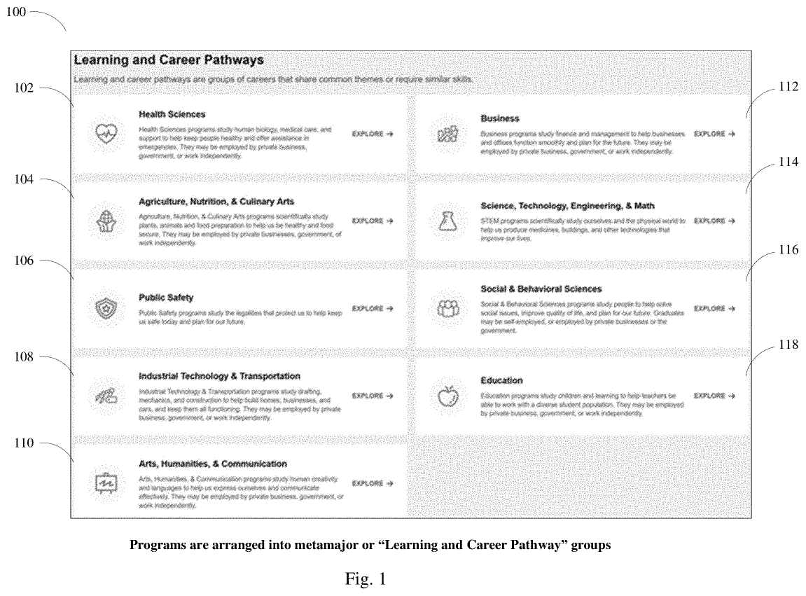

FIG. 1 is an exemplary user interface 100 illustrating various different program groups 102-118 according to some embodiments. Programs groups may be separated within an enclosed box or otherwise delineated from other program groups for easier reading and identifying by users. For example, as illustrated, program groups 102-118 may include one or more learning and/or career pathways or subject matters. Exemplary program groups may include Health Sciences, Business, Agriculture, Nutrition and Culinary Arts, Science, Technology, Engineering and Math, Public Safety, Social and Behavioral Sciences, Industrial Technology and Transportation, Education, Arts, Humanities and Communication, for example. These are merely exemplary and various additional career pathways or arranged groupings may be also used.

As illustrated, the program groups 102-118 may include one or more illustrated icons such as a heart for Health Sciences, a food for Agriculture, a shield for Public Safety, etc. Any arrangement of the icons, text, and headers is relevant in this regard and considered within the scope of the inventive concept. Additionally, the program groups 102-118 may include high level explanations of the program groups. For example, Health Sciences may discuss which industries such as private, or government are affiliated with the said program group. The high-level overview may also explain some of the topics and nature of the work in that program group. In Public Safety, for example, the overview explains that legalities of protection are a focus of the program group.

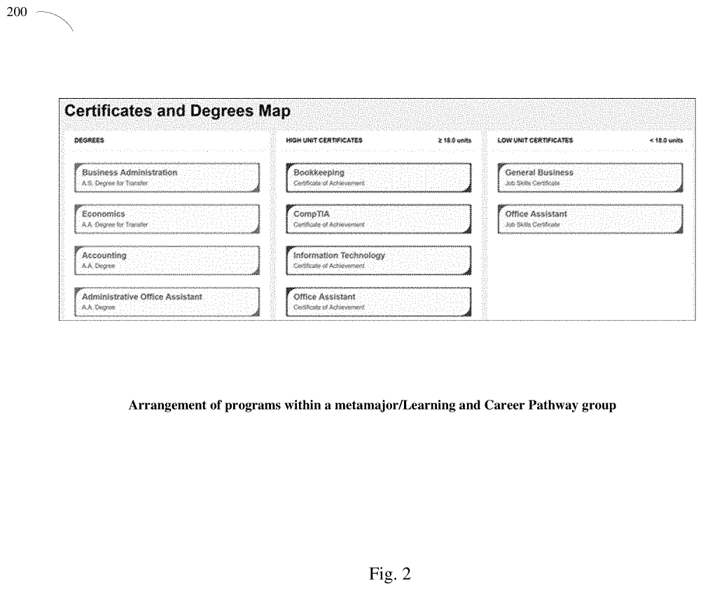

FIG. 2 illustrates an exemplary degree map 200 in a program group according to some embodiments. Degree map 200 may include one or more categories for students to choose such as degrees and certificates. The certificates may be sub-categorized by how many academic units they require, for example, low credit certificates versus high credit certificates. In this way users know easily which programs require how much commitment of time. The degrees may include all of the degrees available at one or more institutions and an indication of the degree type. Degree type may be Bachelor of Arts (B.A.), Associate of Arts (A.A.), Bachelor of Science (B.S.), Associate of Science (A.S.), Master of Arts (M.A.) etc.

The information in the exemplary degree map 200 may be retrieved from one or more local curriculum management system, a chancellor's office curriculum inventory (COCI) or other sources from other universities such as paired universities, etc. The data illustrated in exemplary degree map 200 may be presented after the program mapper data cleanup tool verifies and updates the data, which may be retrieved and cleaned on any interval such as hourly, daily, weekly, monthly, etc.

The data in the exemplary degree map 200 may have various highlighting or shading for the different categories. For example, the degrees may be shaded with one color, pattern, or outline color, and the certificates may be shaded with another color, pattern, or outline color. This may create an easy distinction between degrees and certificates, or between low unit certificates and high unit certificates so that a user can easily recognize the differences without getting confused into making a wrong choice between them.

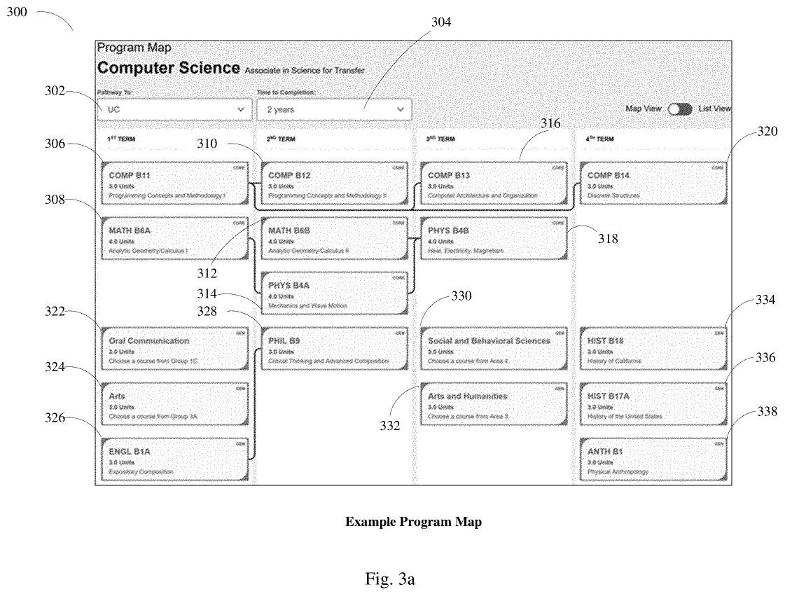

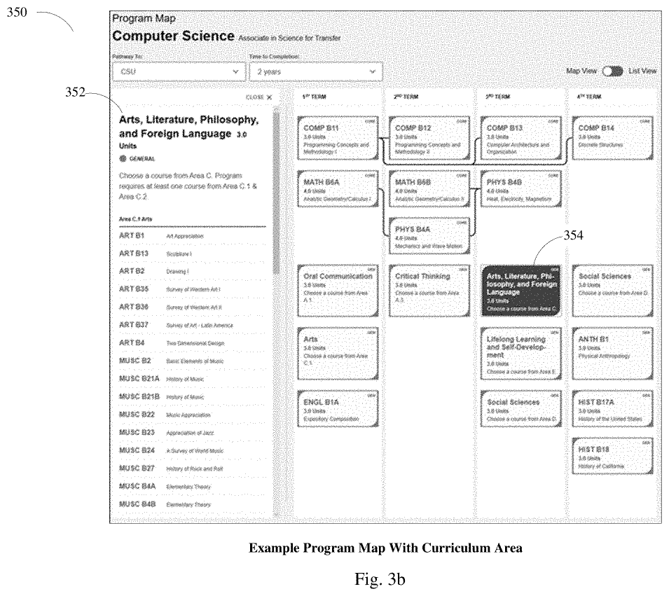

FIG. 3a illustrates an exemplary program map 300 according to some embodiments. Program map 300 may illustrate the specific course requirements and sequences for a degree or certificate. The illustration may be split graphically between required courses and elective courses or non-requisite. In some embodiments, a choice between different schools or pathways may be chosen to dynamically populate a visual representation of the courses for the student or user. Pathway box 302 indicates that “UC” or a pathway to the University of California (UC) system is designated. Box 304 indicates an option for selecting or indicating the number of years or semesters for completion. There may be more than one pathway per program and each pathway in the pathway box 302 may repopulate the data and show a student how they can reach their goal (degree or certificate, for example) or destination (specific transfer program, university, or college).

Boxes 306-320 illustrate the path of courses for degree or certificate completion. Each of Boxes 306-320 shown a required course, with some boxes drawn with an arrow or indicator prefacing another box indicating prerequisites. This way users easily see the pathway, requirements and complexities for coursework in any field. Boxes 306-320 may be drawn, colored, or filled similarly so that a distinction between core courses and electives or general requirements can be made. Similarly, when a user selects one of the courses such as Comp B11 or Phys B4B a further description may appear to the left, right, top or bottom of boxes 306-320 giving a detailed description of the course.

Boxes 322-338 indicate electives or non-major (general) classes that may be required. Some of the electives may be optional. When selecting one of the general units or electives, the user may be presented with further information such as options to satisfy that requirement. For example, when one chooses oral communication, a popup or detailed description box may appear indicating courses such as Public Speaking, Persuasive Communication, or Small Group Communication may be taken to satisfy this requirement. In this way a user can easily navigate between high level and low-level information when trying to decide what to major in as well as what courses to take for a specific pathway.

The program map 300 may be broken down visually by term (1^{st} term or semester, 2^{nd}, 3^{rd}, 4^{th}, etc.). This way the user easily sees how many courses are required each term and how many credits as well.

FIG. 3b illustrates another exemplary program map 350 featuring several curriculum area, for example, curriculum area 354, according to some embodiments. When a curriculum area 354 is selected (highlighted in FIG. 3b), the curriculum area options description box 352 appears. As illustrated, the curriculum area 354 is Arts, Literature, Philosophy, and Foreign Language. Several courses from this area are presented as options of general electives where a student can choose a course among those listed to satisfy the same requirement. As illustrated, the curriculum area options description box 352 appears and presents in detail all of the classes in this area, such as Art Appreciation (Art B1), Sculpture I (Art B13), Drawing I (Art B2), etc. In this way students can easily see the options, select courses, create a personalized syllabus on a clear and intuitive interface.

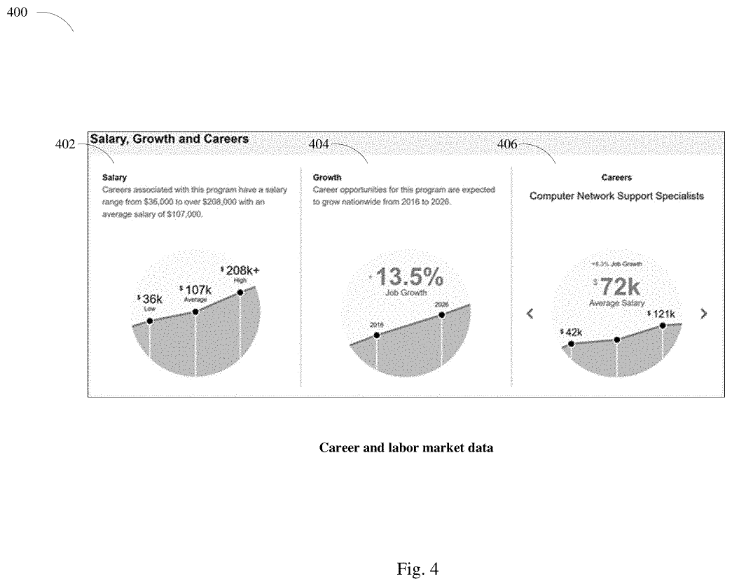

FIG. 4 illustrates exemplary economic data diagram 400 for a pathway according to some embodiments. Economic data diagram 400 may include several boxes, such as salary box 402, growth box 404, and careers box 406. Economic data 400 is intended to give a user a snapshot of a particular career field, what kind of growth or prospects the user can expect and average salaries for the field. Salary box 402 presents a graphical illustration where a low, average, and high points for salaries are presented. The salary data may come from public sources such as the United States Department of Labor. The Standard Occupational Classification (SOC) system may be used along with a Taxonomy of Programs (TOP) code via schema crosswalk using the database of Department of Labor.

Various illustrations or graphic depictions of data may be used, such as an area chart, bar chart, surface chart, doughnut chart, pie chart, etc. Various color schemes may be used for easier identification and reading. For example, the average salary and job growth indicators may be depicted in the same or different color. Multiple careers may be supplied in the careers box with a carousel type graphic selection well known in the online arts.

An exemplary complete embodiment may be where a student or user is presented with the user interface 100 and he or she chooses a program group for viewing or accessing. The user is then shown the degree map 200 for the specific program they chose such as Business or Public Safety. Along with the degree map 200, the user may be shown a highlighted career explorer which highlights average salaries for each or all of the fields within this broader category of Business or Public Safety. For example, the average salary and job growth (plus or minus) may be shown in independent boxes for Accountants and Auditors, Administrative Services Managers, Bookkeeping, Brokerage Clerks, etc. When the user selects one of the fields in the degree map 200 they are presented program map 300 (specific to their choice). Additionally, program learning outcomes and economic data 400 for that field may be displayed on the same page.

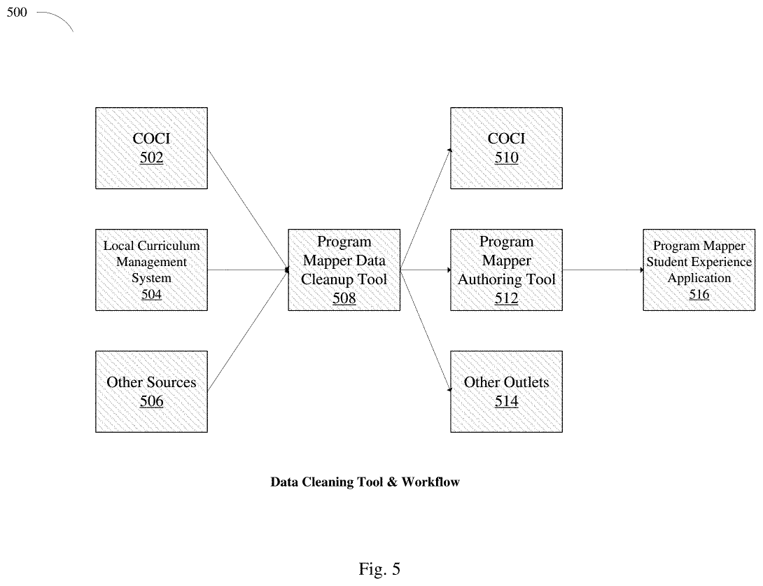

FIG. 5 illustrates an exemplary workflow 500 for the data cleanup tool according to some embodiments. The Program Mapper Data Cleanup Tool 508 may receive data from the chancellor's office curriculum inventory (COCI 502), the local curriculum management system 504, and other sources 506. The COCI 502 may be curriculum data supplied via a database and/or a web interface at a chancellor's or academic director's office. The data may be input yearly, each semester or as often as required. The Local Curriculum Management System 504 may be connected directly to several management systems in different departments. For example, the Computer Science, Education, Business and Public Safety departments may each provide curriculum data which is more up to date. Other sources 506 may include the university or college's course catalog, other colleges which are fed into from Associate's programs, specific deans or professors' workstations, etc.

The Program Mapper Data Cleanup Tool 508 may be configured to examine the collected curriculum data and compare all the sources. The Program Mapper Data Cleanup Tool 508 may process the information available in order to identify incorrect data or inaccuracies from the various sources. The Program Mapper Data Cleanup Tool 508 may then guarantee the received data is clean and organized accurately before being published. The Program Mapper Data Cleanup Tool 508 may be configured to compare the data from the multiple curriculum data sources, determine which information is accurate, publish a definitive source of truth, keep track of the changes made to data from each source, and republish the corrected data back into the original sources.

The Program Mapper Data Cleanup Tool 508 may provide the cleaned data to COCI 510, the Program Mapping Authoring Tool 512 and other outlets 514. The cleaned data may be provided to COCI 510 in order to let the Chancellor's office or relevant office to update their database. The Program Mapping Authoring Tool 512 may include a web interface allowing authorized users to build visual program maps. Data can be locked before arriving at the Program Mapping Authoring Tool 512 so that users can only generate graphical representations and the data integrity is maintained throughout the system. The Program Mapping Authoring Tool 512 may also include one or more administrative functionalities allowing college administrators to review the approved programs.

Program maps may be stored within Program Mapping Authoring Tool 512 before they are published. In-progress maps may be shared between users in order to enable and simplify collaboration. Each map may support transfer to multiple institutions and facilitate the display of articulation agreements with institutions. For example, if a user wants to transfer within the University of California systems or within a particular college or university, the Program Mapping Authoring Tool 512 may allow administrative users to easily view the various plans and articulation agreements between schools to approve or disapprove of students' proposed plans for transfer or graduation. School administrators may use the Program Mapping Authoring Tool 512 to update pathways to alert or display an event at any time, for example, when there is low attendance or when a big event is scheduled.

The Program Mapping Authoring Tool 512 may provide the program maps to the Program Mapper Student Experience Application 516. The Program Mapper Student Experience Application 516 may present the one or more program maps as illustrated and discussed above with respect to FIGS. 1-4. The Program Mapping Authoring Tool 512 may also include an administrative functionality to allow college administrators to review all approved programs. In some embodiments, the Program Mapper Student Experience Application 516 can comply with rigorous usability audits and conform to the WCAG (Web Content Accessibility Guidelines) 2.0 standard for accessibility.

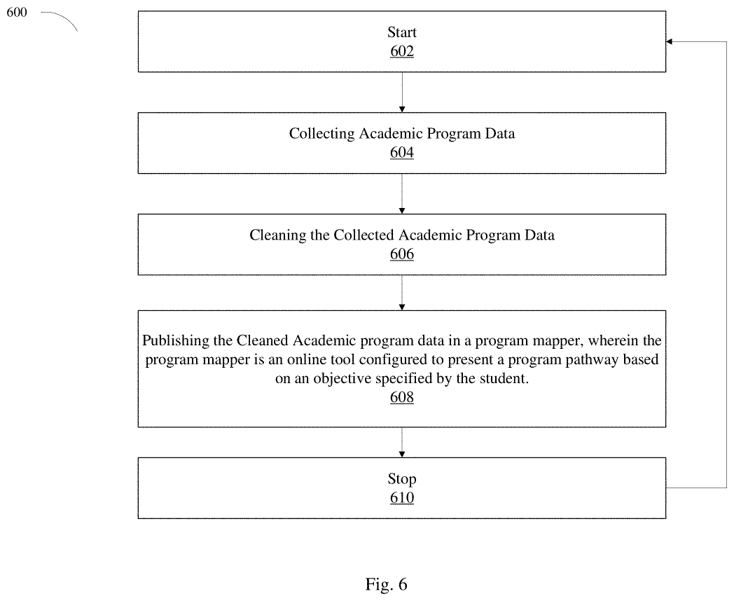

FIG. 6 is a flowchart representation of a method of cleaning and publishing academic program data according to some embodiments. In some embodiments, a device such as a server hosting the Program Planner Mapper (PPM) software may start at step 602 and proceed to step 604. The PPM may collect all the academic program data from the various sources in step 604. For example, course data from each academic department, the Chancellor's office, and local curriculum management databases may be gathered. The PPM may then proceed to step 606.

In step 606, the PPM may perform one of several cleaning methods upon the data. As described above, the PPM may compare curriculum data for each course based on time stamps. The curriculum data with the most recent time stamps or highest version numbers may be identified as the source of truth. The source of truth may be on a per-course, per-pathway, or per-degree basis. The correct version of each course, pathway, degree, certificate, etc. may be identified and marked as the source of truth. Once the data is marked and cleaned, the PPM may proceed to step 608.

The PPM in step 608 may publish the cleaned academic program data. The PPM may use an online or mobile application-based interface to present the pathway or certificate requested by the student. For example, if the student wants to get a degree in Business, the Business pathway for the specified degree such as Associate of Arts may be generated and displayed for the student on screen. Similarly, when the student wants an Associate of Arts degree in Early Childhood Education, then a four-term pathway may be shown including core requirements and electives. The PPM may proceed to step 610 where it may stop or return to step 602 where it may begin again collecting data.

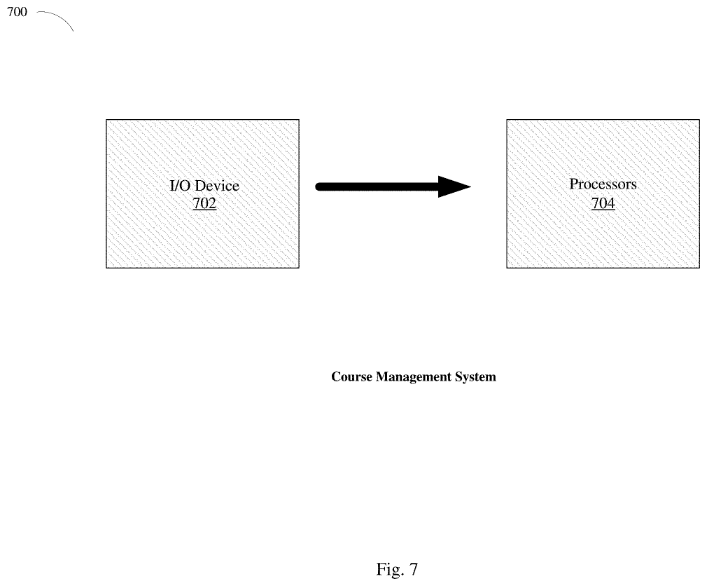

FIG. 7 is a block diagram of a Course Management System 700 according to some embodiments. The Course Management System 700 may include an input/output (I/O) device 702 working in combination with one or more processors 704. The I/O device 702 may be an electronic device such as a server, a file server, web server, database server or personal workstation as described above. The I/O device 702 may include memory, a user interface, storage and/or a network interface interconnected via one or more system buses.

The processors 704 may be any hardware device capable of executing instructions stored in the memory or the storage or otherwise processing data. As such, the processor may include a microprocessor, one or more field programmable gate array(s) (FPGA), application-specific integrated circuit (ASIC), or other similar devices.

The memory may include any of various memory types such as L1, L2, L3 cache or system memory. As such, the memory may include static random-access memory (SRAM), dynamic RAM (DRAM), flash memory, solid state device (SSD), read only memory (ROM), or other similar devices.

The user interface may include any of the interfaces depicted above for enabling communication with a user such as an administrator, a professor, a student or a chancellor. For example, the user interface may include a display, a mouse, a keyboard, a touchscreen, or keypad for receiving user commands. The user interface may include a graphical user interface such as that in FIGS. 1-4. The user interface may include all or part of the Figures combined in various combinations and sequences.

The network interface may include one or more devices for enabling communication with other hardware devices. For example, the network interface may include a network interface card (NIC) configured to communicate according to the Ethernet protocol. Additionally, the network interface may implement a TCP/IP stack for communication according to the TCP/IP protocols. A 4G/5G/LTE, Wi-Fi, or any other wireless protocol may similarly be used. Various alternative or additional hardware or configurations for the network interface will be apparent to one of skill in the art including Bluetooth, and NFC.

The storage may include one or more machine readable storage media such as ROM, RAM, SSD, magnetic disk storage media, optical storage media, flash memory devices, etc. In various embodiments, the storage may store instructions for execution by the processors 704 or data upon which the processors 704 may operate. For example, the storage may store course catalog information, program pathways, programs groups, degree maps, detailed curriculum data, job growth and salary data, etc. The storage may also store one or more user interfaces described and presented herein.

It will be apparent to one in the art that various information described as stored in the storage may be additionally or alternatively stored in the memory. All memory and storage may include non-transitory machine-readable instructions. Both storage and memory may be considered non-transitory machine-readable media. All functions of the embodiments can be accomplished by software executed on computer processors. The processors 704 may be configured to provide information processing capabilities in various computing devices. The processors 704 may include one or more of the following: digital processor, analog processor, digital circuit designed to process information, analog circuit designed to process information, state machine, and/or other mechanisms for electronically processing information.

In some implementations, processors 704 may include a plurality of processing units. These processing units may be physically located within the same device, or processor(s) may represent processing functionality of a plurality of devices operating in coordination. Processor(s) may be configured to execute modules by software, hardware, firmware, some combination thereof, and/or other mechanisms for configuring processing capabilities on processor(s). As used herein, the term “module” may refer to any component or set of components that perform the functionality attributed to the module. This may include one or more physical processors during execution of processor readable instructions, the processor readable instructions, circuitry, hardware, storage media, or any other components.

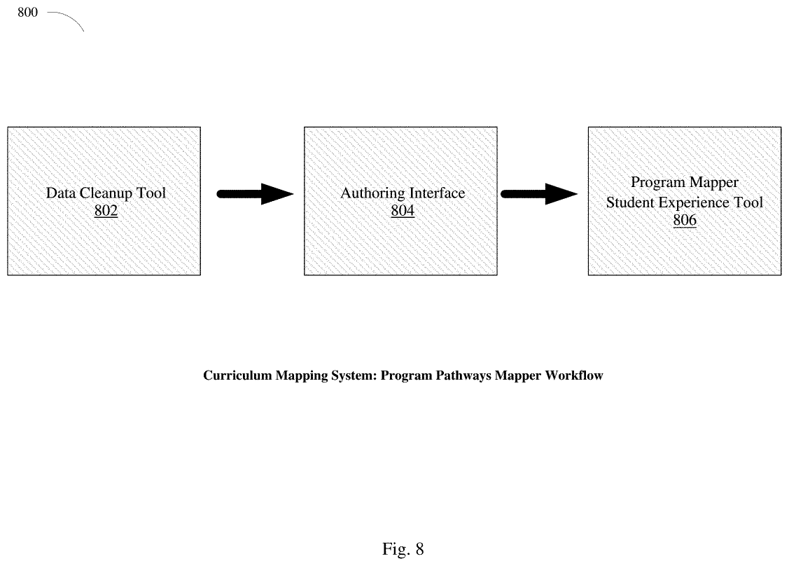

FIG. 8 illustrates an exemplary Curriculum Mapping System 800 including a program pathways mapper workflow, according to some embodiments. The Curriculum Mapping System 800 may include a data cleanup tool 802, an authoring interface 804 and a program mapper student experience tool 806. The data cleanup tool 802, authoring interface 804 and program mapper student experience tool 806 may be present and executed on the same device or storage or copied and distributed to multiple devices for presentation.

The data cleanup tool 802 may receive data from one or more sources. For example, the data cleanup tool 802 may receive curriculum, course, certificate or program data from the COCI, a professor, a program or a yearly syllabus. The data cleanup tool 802 may cleanup the data by doing a program by program comparison. For example, the most updated data may be stored on the system that is configured to execute the data cleanup tool 802 in one or more databases. The data cleanup tool 802 may do a course by course comparison to see which is the most accurate course description, numbering, and title. Similarly, the data cleanup tool 802 may do a program map or program completion comparison for verifying whether a sequence of courses is up to date with the current requirements for a degree or certificate. In some cases, some courses may be outdated, some courses may no longer be required, or a newly required course may be added, for example.

The authoring interface 804 may include a web or online interface for authorized users to build visual program maps. For example, the data may be locked by the data cleanup tool 802, but colors, highlights, order of courses, shading, outlines, and other graphical elements may be modified within the authoring interface 804. The maps may be stored for several years historically, and further maps may be shared between users, professors or administrators to enable collaboration. Transfer between universities or colleges may also be supported within the authoring interface 804. For example, articulation agreements may be displayed to facilitate and help transfer of programs. When a student transfers to another school, the schools may collaborate using the methods and systems described herein to ensure the transferring student's timely baccalaureate completion. The authoring interface 804 may also be displayed via a mobile application, or desktop application enabling interaction with the data cleanup tool 802 and program mapper student experience 806.

The data and maps finalized in the authoring interface 804 may be presented on the program mapper student experience tool 806. The program mapper student experience tool 806 may be an application on a mobile device or a web-based interface that displays the various information and maps described above as well as with reference to FIGS. 1-4.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method of processing curriculum data for helping a student to navigate curriculum programs, comprising:
collecting academic program data of a first institution;
cleaning the collected academic program data; and
publishing the cleaned academic program data in a program mapper, wherein the program mapper is an online tool configured to present a program pathway based on an objective specified by the student.

2. The method of claim 1, further comprising:
collecting occupational or labor market data, wherein the program mapper is configured to integrate the collected academic program data and the collected occupational and labor market data for display.

3. The method of claim 1, wherein cleaning the collected academic program data comprises removing conflicting data collected from different sources.

4. The method of claim 3, wherein cleaning the collected academic program data further comprises correcting inaccurate data by determining which source is accurate.

5. The method of claim 1, wherein the objective specified by the student includes an academic credential in a field of study or a career selection in an industry.

6. The method of claim 1, wherein the program pathway comprises a course requirement for achieving the objective specified by the student.

7. The method of claim 6, wherein the program pathway further comprises time information related to the course requirement for achieving the objective specified by the student.

8. The method of claim 1, wherein the program pathway comprises one or more program maps, with each program map showing one or more possible course sequences for earning a program award.

9. The method of claim 1, wherein the program pathway comprises one or more curriculum areas, wherein each curriculum area includes two or more classes that meet a same requirement.

10. The method of claim 1, further comprising:
keeping track of the student's progression along the program pathway towards the objective.

11. The method of claim 1, further comprising:
collecting academic program data of a second institution;
integrating the academic program data of the first institution with the academic program of the second institution; and
publishing the integrated program data in the program mapper, wherein the integrated program data allows a student to matriculate in both institutions to achieve the objective of the student.

12. A course management system, comprising:
an input/output (I/O) device for receiving academic program data;
one or more processors configured to:
clean the academic program data; and
publish the academic program data in a program mapper, wherein the program mapper is an online tool configured to present, on the I/O device, a program pathway based on an objective specified by the student.

13. The course management system of claim 12, wherein the one or more processors are further configured to:
maintain records of updates to academic program data made during the cleaning of the data, such that the same updates can be made to new data at a later point in time.

14. The course management system of claim 12, wherein the one or more processors are configured to collect occupational or labor market data, wherein the program mapper is configured to integrate the collected academic program data and the collected occupational or labor market data and publishing the integrated data.

15. The course management system of claim 12, wherein cleaning the collected academic program data comprises removing conflicting data collected from different sources.

16. The course management system of claim 12, wherein the program pathway comprises a course requirement for achieving the objective specified by the student.

17. The course management system of claim 16, wherein the program pathway further comprises time information related to the course requirement for achieving the objective specified by the student.

18. The course management system of claim 12, wherein the one or more processors are further configured to generating, in response to a school administrator's specification, program maps based on the cleaned academic data, with each program map showing one or more possible course sequences for earning a program award.

19. The course management system of claim 18, wherein the program pathway comprises one or more of the program maps.

20. The course management system of claim 12, wherein the one or more processors are further configured to keep track of the student's progression along the program pathway towards the objective.

21. A curriculum program mapping system, configured to facilitate a student to navigate curriculum programs, comprising:
a data cleanup tool for cleaning academic program data collected from different sources;
an authoring tool for academic administrator to create program maps out of the cleaned data; and
a program mapper for presenting the cleaned program data as program pathways for students to navigate curriculum programs.

22. The curriculum program mapping system of claim 21, further comprising an authoring tool for creating a program map, wherein each program map shows a possible course sequence for earning a program award and wherein a program pathway comprises one or more program maps.
